(19) United States
(12) Patent Application Publication
(10) Pub. No.: US 2020/0053117 A1
(43) Pub. Date: Feb. 13, 2020

(54) METHOD, SYSTEM, AND/OR SOFTWARE FOR FINDING AND ADDRESSING AN INFORMATION/DATA OR RELATED SYSTEM'S SECURITY RISK, THREAT, VULNERABILITY, OR SIMILAR EVENT, IN A COMPUTING DEVICE OR SYSTEM

(71) Applicant: TELESIS CORPORATION, McLean, VA (US)

(72) Inventor: Monisha Shashi MANDAL, Ashburn, VA (US)

(73) Assignee: TELESIS CORPORATION, McLean, VA (US)

(21) Appl. No.: 16/375,069

(22) Filed: Apr. 4, 2019

Related U.S. Application Data
(60) Provisional application No. 62/715,310, filed on Aug. 7, 2018.

(51) Int. Cl. H04L 29/06

(52) U.S. Cl. CPC H04L 63/1433

(57) ABSTRACT

A computing device-implemented method of managing a security risk in a computer system or network, includes a) determining an appropriate security level for the computer system or network, b) selecting, using a security authorization module, one or more suitable controls applicable to the security level based on one or more predetermined criteria, c) implementing the selected one or more controls, d) monitoring the system or network for any vulnerability, e) reporting any vulnerability found to a vulnerability module for remediation, f) tracking, using the vulnerability module, the progress of the remediation to completion, g) reporting to a findings module for remediation, if the vulnerability is not remediated within a preset period of time, and h) tracking, using the findings module, the progress of the remediation reported in step g) to completion.

### CROSS-REFERENCE TO RELATED APPLICATIONS

The present application claims priority on prior U.S. Provisional Application Ser. No. 62/715,310, filed Aug. 7, 2018, which is hereby incorporated herein in its entirety by reference.

### FIELD AND BACKGROUND OF THE INVENTION

The present invention is generally directed to information and data, and information/data system security, and more particularly to a method, system, and/or software for finding and addressing an information/data or related system's security risk, threat, vulnerability, or a similar event, in a computing device or system.

The modern ubiquitous computing devices and systems are making data processing and computations faster than ever, and communication instantaneous. Data processing capabilities and speeds of the seventies room-size computers are now readily available in palm size devices. The eighties bulky cellular communication devices have now been substituted by miniaturized wearable wrist watch-type devices that can easily boast more communication power and capabilities, and of course, ease of use and enhanced convenience for the users. The Internet has turned information highways into super-fast communication channels that have easily collapsed the traditional borders between the countries and made the flow of data and information entirely unobstructed on a global scale.

Although the ardent embrace of the modern data processing and communication technologies is convenient, desirable, and incredibly utilitarian, protection and secure maintenance of information, data, and information/data systems, particularly from unauthorized or criminal access, has presented unique challenges. The recently coined term “Cybersecurity” has acquired a critical and important status in data processing, and management of communication and information technologies, to name a few. Governments on a global scale have rightly been concerned with and are taking appropriate measures to reduce, prevent and hinder “hacking,” or unauthorized or criminal access, and strengthening security. Guidelines have been proposed and promulgated to identify risks or threats or vulnerabilities, and to take appropriate countermeasures, including enhancing device or system security.

### Problems Facing Federal Agencies

Every IT system in the Federal Government must comply with FISMA (Federal Information Security Management Act of 2002), via FIPS-199 and FIPS-200 and the NIST (National Institute of Standards and Technology) guidelines. Currently the cost of Cybersecurity skills is high as good skills are in short supply and high demand. Agencies spend too much time on low-value, mundane tasks-formatting documents, cross-walking regulations, and manually tracking Plan of Action and Milestones (POA&M's). The requirements set for Continuous Monitoring, Security Authorization, and Risk Management are complex and time-consuming processes. Non-compliance is not an option; and at risk are your IT budget, taxpayer information, and security, etc.

### OMB (Office of Management Budget) Annual Report to Congress 2017—Section on POA&M

In accordance with the OMB Annual Report to Congress 2017:
18 IG's reported that their departments had POA&Ms in place.
6 Of these 18, indicated that their department's programs had all of the required attributes.
12 IGs indicated that their programs needed improvements. The following issues were most common: The department did not track, prioritize and remediate weaknesses (four departments)
   The department did not ensure remediation plans were effective for correcting weaknesses (four departments);
   The department had not established and adhered to milestone remediation dates (nine departments);
   The department did not develop POA&Ms for security weaknesses discovered during assessments of security controls that require planned mitigation (five departments); and,
   The department did not associate costs with remediating weaknesses and are identified in terms of dollars (seven departments).

One software tool known as “OpenFISMA” has been available to be utilized for improving information/data/information system security. Specifically, OpenFISMA is a tool that tracks findings for federal agencies. The tool has the Findings module that allows an organization to centralize all audit information, documentation and processes, correlation of evidence, and observations and remediation efforts in a single, access-controlled solution. The findings module stores Plans of Actions and Milestones (POA&Ms) for all security deficiencies. The OpenFISMA findings module is designed to help agencies easily implement a program that meets federal requirements. The findings module is predicated on the obvious fact that information system security spans the entire enterprise; different people in different organizational groups will need to collaborate to ensure that plans are correct, timely, and documented thoroughly. The module aims to assist in expediting this effort by centralizing the tracking and providing automatic e-mail notifications in response to key events in the business process. There are several real-time reports and dashboards to monitor and track the status of all open deficiencies.

### Business Process Terms (FIG. 1)

OpenFISMA used the following terms to map the business process into an electronic record format.

NEW
A finding enters NEW status when it is first entered into the system.
All fields are editable in this state.

DRAFT
A finding enters DRAFT when the Course of Action Type (CAP, AR, or FP) has been entered and saved.
All fields are editable in this state.
MS ISSO (Mitigation Strategy approval by ISSO) A finding enters MS ISSO when a user clicks the “Submit Mitigation Strategy” button on the Remediation Detail page.
All of the fields are locked in this state.

MS IV&V (Mitigation Strategy approval by IV&V)
A finding enters MS IV&V when the ISSO approves the mitigation strategy.
All of the fields are locked in this state.

EN (Evidence Needed)
A finding enters EN when the IV&V approves the mitigation strategy.
At this point, a user will need to execute the mitigation strategy and upload an evidence package that demonstrates the results.
All of the fields are locked in this state, except evidence can be uploaded.

EV ISSO (EVidence approval by ISSO)
A finding enters EV ISSO when a user uploads an evidence package.
All of the fields are locked in this state.

EV IV&V (EVidence approval by IV&V)
A finding enters EV IV&V when the ISSO approves the evidence package.
All of the fields are locked in this state.

CLOSED
A finding enters CLOSED when the IV&V approves the evidence package.

OpenFISMA, however, has limited capabilities. The tool has only the findings module and a very basic and rudimentary risk analysis capability, OpenFISMA is especially lacking, for example, in integration capabilities with other tools within an organization/environment and does not cover, for example, many aspects of the NIST Risk Management Framework.

### ASPECTS AND SUMMARY OF THE INVENTION

The present disclosure is directed to various aspects of the present invention.

One aspect of the present invention is to provide a method, system, and/or software or tool (hereinafter “mechanism”) for finding/detecting and addressing an information/data or related computer or system security risk, threat, vulnerability, or similar event in a computing device, system, and/or network.

Another aspect of the present invention is to provide a mechanism that greatly facilitates and improves compliance with government-mandated requirements to monitor, manage, and/or mitigate information/data or related risk, threat, vulnerability or similar event in a computing device, system, and/or network.

Another aspect of the present invention is to provide a mechanism that substantially reduces costs associated with compliance with government-mandated requirements to monitor, manage, and/or mitigate information/data or related risk, threat, vulnerability or similar event in a computing device, system, and/or network.

Another aspect of the present invention is to provide a mechanism that greatly improves the connectivity, defense, efficiency, safety, security, and/or manageability of an underlying computer, system, or network and data by early detection and prompt remediation/mitigation of a risk, threat, vulnerability, or similar event, whether actual or attempted, in a computing device, system, and/or network.

Another aspect of the present invention is to provide a mechanism that averts, eliminates, or significantly reduces the probability of a catastrophe, disablement, or failure of an underlying computer, system, or network by early detection and prompt remediation/mitigation of a risk, threat, vulnerability, or similar event in a computing device, system, and/or network.

Another aspect of the present invention is to provide a mechanism that is versatile and scalable and can be effectively used in many different industries including, but not limited to, private and government enterprises, banking, education, energy, environment, health, space, etc.

Another aspect of the present invention is to provide a mechanism that offers tremendous flexibility to users in various applications in being modular. Specifically, a preferred embodiment includes findings, vulnerability, and security and authorization modules that can function independently or inter-dependently depending upon the user's needs and roles in an organization.

Another aspect of the present invention is to provide a mechanism that delivers, for example, compliance, threat levels, and management data in comprehensive user-friendly views for immediate analysis and action.

Another aspect of the present invention is to provide a computing device-implemented method of managing a security risk in a computer system or network, including a) determining an appropriate security level for the computer system or network, b) selecting, using a security authorization module, one or more suitable controls applicable to the security level based on one or more predetermined criteria, c) implementing the selected one or more controls, d) monitoring the system or network for any vulnerability, e) reporting any vulnerability found to a vulnerability module for remediation, f) tracking, using the vulnerability module, the progress of the remediation to completion, g) reporting to a findings module for remediation, if the vulnerability is not remediated within a preset period of time, and h) tracking, using the findings module, the progress of the remediation reported in step g) to completion.

Another aspect of the present invention is to provide a computing device-implemented method of identifying and tracking to closure a security risk, threat, or deficiency in a computer system or network, including a) parsing, using a vulnerability module, scanned data from a computer system or network, b) identifying any vulnerability based on one or more compliance with predetermined criteria, c) reporting any vulnerability found in step b) to an administrator for remediation, d) tracking, using the vulnerability module, the progress of the vulnerability remediation to completion, e) reporting to a findings module for remediation, if the vulnerability remediation is not completed within a preset period of time, and f) tracking, using the findings module, the progress of the remediation reported in step e) to completion.

Another aspect of the present invention is to provide a non-transitory computer-readable medium with instructions stored thereon, that when executed by a processing device, perform the steps including a) parsing, using a vulnerability module, scanned data from a computer system or network, b) identifying any vulnerability based on compliance with one or more predetermined criteria, c) reporting any vulnerability found in step b) to an administrator for remediation, d) tracking, using the vulnerability module, the progress of the vulnerability remediation to completion, e) reporting to a findings module for remediation, if the vulnerability remediation is not completed within a preset period of time, and f) tracking, using the findings module, the progress of the remediation reported in step e) to completion.

Another aspect of the present invention is to provide a system for identifying and tracking to closure a security risk, threat, or deficiency in a computer system or network, including: a) a first processor that runs a vulnerability module for i) scanning data from a computer system or network to identify a vulnerability based on compliance with predetermined criteria, ii) reporting the vulnerability found to an administrator for remediation, iii) tracking the progress of the vulnerability remediation to completion, and iv) reporting to a findings module for remediation if the vulnerability remediation is not completed within a present period of time; b) a second processor that runs a findings module for i) tracking the progress of the vulnerability remediation received from the vulnerability module to completion, and ii) logging the received vulnerability remediation from the vulnerability module as a risk, threat, or deficiency reportable to a governmental authority; and c) a third processor that runs a security and authorization module for i) selecting, based on one or more predetermined criteria, one or more security controls applicable to a security level for the computer system or network, and ii) implementing the selected one or more security controls in the computer system or network.

In summary, the present invention provides various preferred embodiments of a computing device-implemented mechanism(s) for implementing and/or managing a security risk, threat, vulnerability, or similar event in a computing device, computer system, and/or computer network.

### BRIEF DESCRIPTION OF THE DRAWINGS

One of the above and other aspects, novel features and advantages of the present invention will become apparent from the following detailed description of a preferred embodiment(s) of the invention, as illustrated in the drawings, in which:

FIG. 1 illustrates a block diagram/process workflow of a conventional module known as OpenFISMA;

FIG. 2 illustrates a block diagram of various modules in accordance with a preferred embodiment of the present invention styled “OpenFISMA+”;

FIGS. 3 and 4 illustrate a sample dashboard showing, as dynamic view in column charts, the status of the system by Findings Workflow (FIG. 3) and Findings Past Completion Date (FIG. 4), in accordance with a preferred embodiment of the present invention styled “OpenFISMA+”;

FIG. 5 illustrates a summary workflow/flowchart of OpenFISMA+ in accordance with a preferred embodiment of the present invention;

FIG. 6 illustrates a summary workflow/flowchart of System Assessment and Authorization thread shown in in FIG. 5;

FIG. 7 illustrates a summary workflow/flowchart of Authorization to Operate (ATO) Documentation thread shown in FIG. 5;

FIG. 8 illustrates a summary workflow/flowchart of Vulnerability thread shown in FIG. 5;

FIG. 9 illustrates a summary workflow/flowchart of Findings/Plan of Action & Milestones (POA&Ms) thread shown in FIG. 5;

FIG. 10 illustrates a workflow/flowchart of findings dashboard accordance with a preferred embodiment of the present invention;

FIG. 11 illustrates a workflow/flowchart of findings detail in accordance with a preferred embodiment of the present invention;

FIG. 12 illustrates a workflow/flowchart of findings upload in accordance with a preferred embodiment of the present invention;

FIG. 13 illustrates a workflow/flowchart of vulnerability dashboard in accordance with a preferred embodiment of the present invention;

FIG. 14 illustrates a workflow/flowchart of vulnerability details in accordance with a preferred embodiment of the present invention;

FIG. 15 illustrates a workflow/flowchart of vulnerability upload in accordance with a preferred embodiment of the present invention;

FIG. 16 illustrates a workflow/flowchart of security authorization dashboard in accordance with a preferred embodiment of the present invention;

FIG. 17 illustrates a workflow/flowchart of system security in Risk Management Framework (RMF) in accordance with a preferred embodiment of the present invention;

FIG. 18 illustrates a block diagram of the system architecture in accordance with a preferred embodiment of the present invention;

FIG. 19 is a graphical representation of system architecture in accordance with a preferred embodiment of the present invention;

FIG. 20 illustrates a risk management framework utilizing a preferred embodiment of the present invention; and

FIG. 21 is a pictorial/graphical representation showing OpenFISMA+ integration with Continuous Diagnostic Monitoring (CDM) in accordance with a preferred embodiment of the present invention.

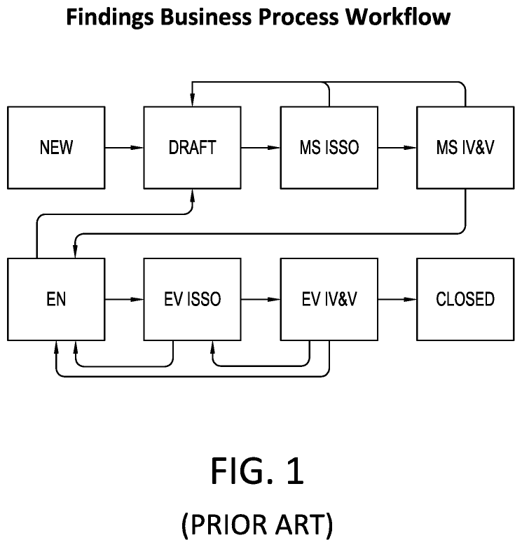

### DETAILED DESCRIPTION OF THE PREFERRED EMBODIMENT(S) OF THE INVENTION

OpenFISMA⁺ (OF+) is an enterprise level method, system, and/or software or tool (hereinafter “mechanism”) that provides a significantly improved framework for managing Information Technology (IT)/information security risk and compliance needs, at least of security assessment, continuous monitoring, and ongoing authorization. The mechanism:
Provides for a centralized management of Plan of Action and Milestones for systems (POA&M's)
Automates system inventory and the FISMA reporting requirements.
Focuses on the Risk Management Framework

It is noted herewith that the present invention, and various preferred embodiments thereof, are described/illustrated herein with reference to “OpenFISMA+”, merely for convenience and ease of understanding, and are not therefore limited in anyway by or to FISMA and/or any related/sister acts, laws, statutes, rules, regulations, policies, practices, and/or requirements.

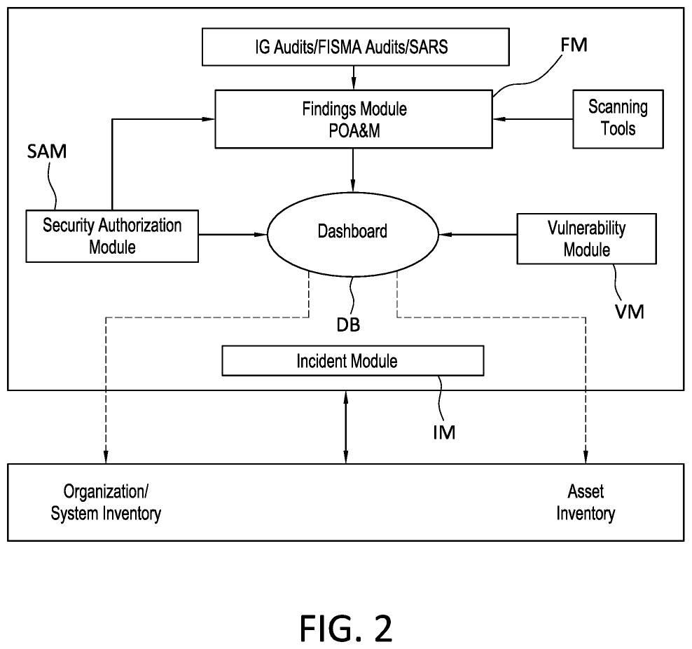

As shown in FIG. 2, OpenFISMA+ is preferably organized into and includes the following non-limiting modules, which feed into a dashboard DB:
Findings Module (FM);
Security Authorization Module (SAM);
Vulnerability Module (VM); and
Incident Module (IM).

The above modules use the baseline foundational modules of System Organization/Inventory and Administration (SOIA) that is also included in the tool.

### OpenFISMA+ Modules

The separate OpenFISMA+ modules provide an administrator the ability to disable some of the modules or provide access to a module based on a user's role. Thus, the modules can run individually or inter-dependently. The following summarizes the preferable function(s) of each module.

All of the modules are represented in OpenFISMA+ using the menu bar. The menu items available within each module are organized in a consistent way across all of the modules.

The first section contains the preferable primary features of the module. In the Findings Module (FM), this includes the Summary feature, the Search feature, and “Go To.” feature.

The second section contains the preferable secondary features of the module. This example shows “Create New Finding” and “Upload Spreadsheet” as secondary features.

The last section is standardized across all modules and preferably contains three components:

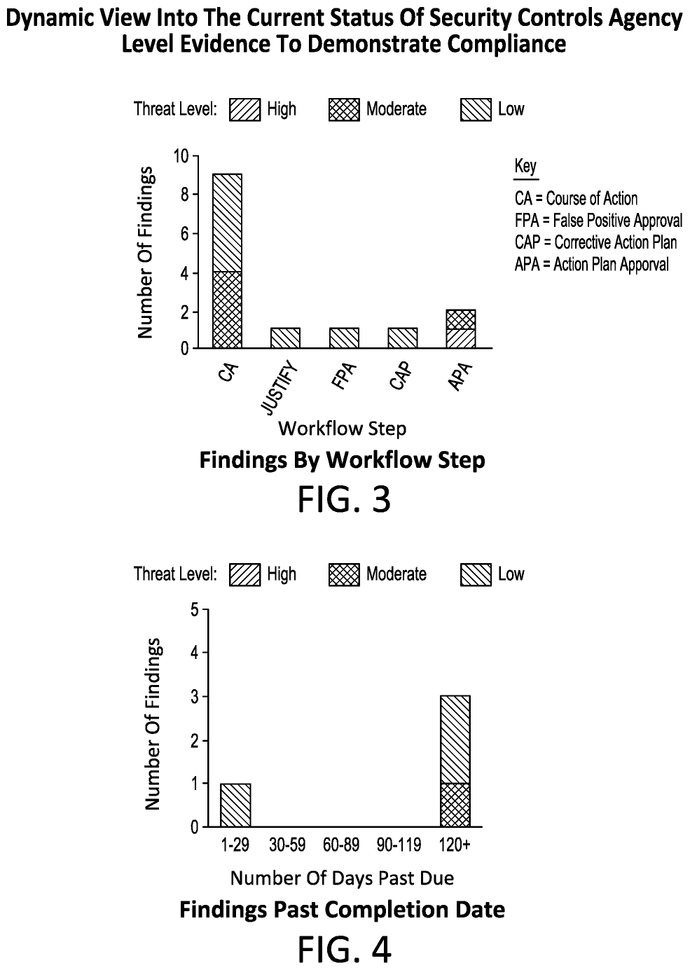

1. Dashboard
1. A high level, graphical summary of data within the module (FIG. 3).

2. Administration
1. Contains administrative tasks that are specific to this module.
2. (Global administrative tasks are handled somewhere else.)

3. Reports
1. Contains canned reports related to the data within the module.

Brief Functionalities of the Modules

| Module | Description |
|---|---|
| Findings | One of the main FISMA requirements is for Federal Agencies to track, |
| | manage, and monitor agency Plans of Actions and |
| | Milestones (POA&M's) for security findings and control |
| | deficiencies. |
| | The Findings Module (FM) is built around a real-world business |
| | process for tracking POA&Ms which enforces segregation of |
| | duties and imposes deadlines in order to keep the process |
| | moving forward. In addition to optimizing the business process, |
| | this module creates transparency and tracking options that are |
| | not feasible under a document-based management approach. |
| Vulnerabilities | The Vulnerabilities Module (VM) tracks and aggregates the output |
| | of third-party vulnerability scanners. The Security Content |
| | Automation Protocol (SCAP)-enabled module can match |
| | duplicate vulnerabilities across different vulnerability scanning |
| | products, compare risk using Common Vulnerability Scoring |
| | System (CVSS), and enables quick tracking and resolution of |
| | vulnerability records. The vulnerabilities that are not resolved are |
| | converted into findings to be tracked in the Findings module |
| Security | This module provides the system user with implementing steps to |
| Authorization | meet all the needs of the NIST Risk Management Framework so |
| | as to get the system an Authority to Operate, and manage the |
| | continuous monitoring of the system |
| Incidents | This module tracks security incidents. It provides a very rich data |
| | model to capture contact details, threat source, affected assets, |
| | resolution steps, and both internal/external communication paths |
| | related to security incidents. |

Foundational Modules

| | |
|---|---|
| System | The System Inventory component in OpenFISMA+ tracks IT |
| Inventory | management organizations, information systems managed by |
| | those organizations, and assets contained within the boundaries |
| | of those information systems. These three types (organization, |
| | system, and asset) comprise a hierarchy that provides several |
| | different levels of detail for information. The primary purpose for |
| | tracking these items is to provide the capability to automatically |
| | track information related to FISMA compliance, view it at a high |
| | level (per organization), medium level (per system), or low level |
| | (per asset). These varying levels of detail enable OpenFISMA+ to |
| | provide meaningful information to all parties involved in securing |
| | information. High-level dashboards and reports can guide |
| | program policy, while front-line system administrators can obtain |
| | detailed technical information required to implement complex |
| | solutions. |
| Administration | The administration module is specific to managing the tool. Most |
| | average end users will not see or use the administration module. |

### Preferable Features of the Modules

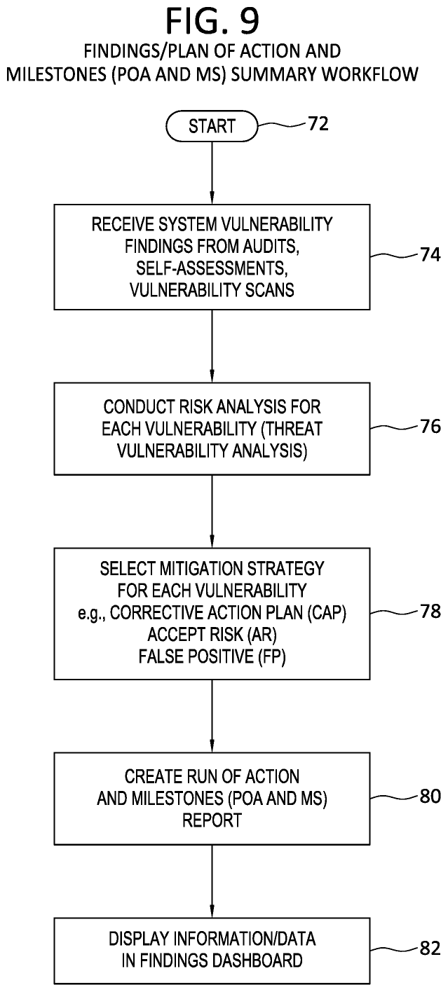

### Findings Module (FIGS. 9-11)

The Findings Module (FM) in OpenFISMA+ allows an organization to centralize all audit information, documentation and processes, correlation of evidence, and observations and remediation efforts in a single, access-controlled solution. The findings module is a preferable place for the Federal Agencies to store Plans of Actions and Milestones (POA&Ms) for all security deficiencies. The module aims to assist in expediting this effort by centralizing the tracking and providing automatic e-mail notifications in response to key events in the business process. There are several real-time reports and dashboards to monitor and track the status of all open deficiencies. The Findings Module (FM) focuses on tracking findings that may have been created during continuous monitoring, audits, self-assessments.

Before delving deeper into how the module works, it will be useful to step back and look at the business process that the module implements, thereby improving the security and efficiency of a system, while reducing or eliminating vulnerabilities from, for example, unauthorized intrusions. Specifically, in a typical information security audit at a large organization:

The organization hires an auditor (either internal or external) to review the security state of an information system.

The auditor assesses the security state and writes a report.

The report contains a list of findings (a.k.a. deficiencies) discovered during the assessment.

The organization plans to respond to each of the individual findings.

The organization executes each plan, collecting documentation along the way to prove that the deficiency has been corrected.

Some central body tracks the status of each plan, such as when it is due, whether it is complete, and if it is overdue or on schedule.

One skilled in the art would readily appreciate that the above-noted procedure is tedious since documents and spreadsheets require additional time to organize, update, and re-distribute every time that changes are made. Additionally, the procedure requires labor and introduces lag time into the overall process. OpenFISMA+ significantly speeds up this process by automatically enforcing business rules, sending automatic updates to interested parties, and organizing all content for easy searching and reporting.

### Findings Module (FM) Dashboards

The module has various dashboards that provide a synopsis view to the user.

The 3 preferable dashboards include—

An Executive Dashboard

A System Analyst View

A Summary View

The executive dashboard provides senior management with a view that enables them to make quick decisions related to the security posture of the agency. For example, it provides the management with information such as number of POA&M'S that have been completed in a defined period of time, those that are approaching their completion and those that have not been addressed. See FIG. 7.

The system analyst view provides the user with a similar view to the executive management but only related to those systems for which the analyst is responsible.

The summary view is a roll up table that provides the details of every finding. The Completion Date of the findings are marked in red to highlight those that did not meet their due date.

### Finding Detail Summary

The finding detail page provides the user with necessary information such as the source of the finding, description of the finding, the estimated completion date (ECD), the due date, the Common Vulnerabilities and Exposures (CVE) if applicable, the person assigned the system, the organization. OpenFISMA+ tracks the ECD for individual findings in order to make sure that findings are being processed in a timely manner.

### Finding Creation/Upload

A finding is created by an auditor after an assessment has been completed. The finding represents a material weakness in the security program that was revealed by the audit. There are two ways to create findings:

### 1. Direct Entry

### 2. Upload Spreadsheet

The direct entry method requires a user to have a login account for OpenFISMA+ with the appropriate privileges. This method requires the user to enter findings one-by-one.

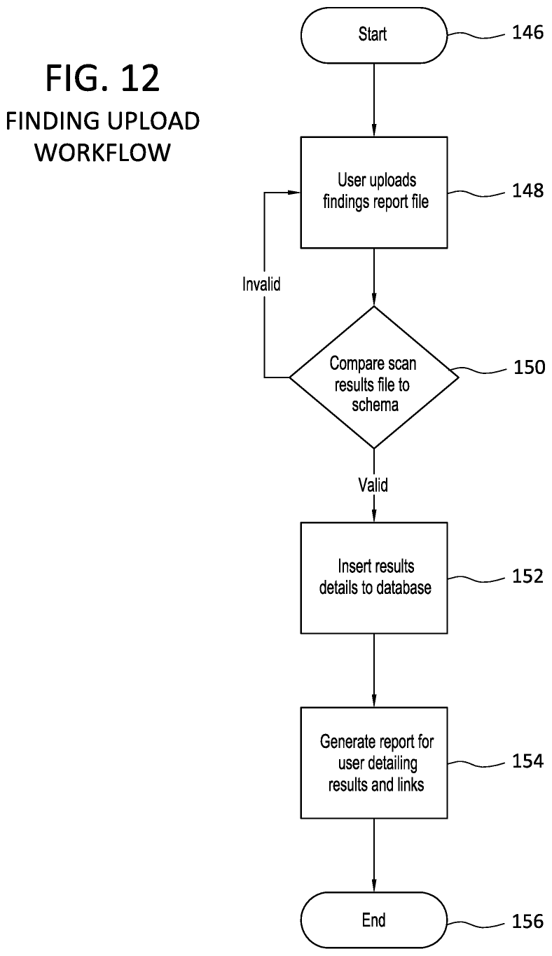

The spreadsheet method the user to enter multiple findings all at once. Multiple findings can be uploaded via an excel spreadsheet or individual findings can be created within the tool through the findings upload process (described below in more detail and illustrated, for example, in FIG. 12).

Once the finding is created it follows a process for user access determination, finding detail display, selection of impact, selection of countermeasures, risk analysis to determine risk mitigation approach of false positive, corrective action, or risk acceptance.

### Mitigation Types

Preferably, there are three mitigation types available for a finding:

CAP—Corrective Action Plan

A corrective action plan is a mitigation strategy that aims to reduce the overall risk of a finding by correcting the underlying deficiency.

AR—Accept Risk

An accept risk is a mitigation strategy that aims to reduce risk down to an acceptable level, then seek official sign-off from the authorizing official.

FP—False Positive

A false positive is not a true mitigation strategy, per se, but it is a plan to document that the auditor's finding did not exist as documented on the day that it was observed.

### Preparing a Mitigation Plan

Once a finding has been entered, the next step is to plan the response. We call this the “mitigation plan”. As mentioned above, there are three basic mitigation approaches: 1) corrective action plan (CAP), 2) accept risk (AR), or 3) false positive (FP).

The mitigation plan must be documented. The information required include—
Description uploaded in OpenFISMA+ to prove that the plan has been executed successfully.
Resources Required
Expected Completion Date
Risk Analysis—Countermeasures, threat and security control fields.

The person assigned can save work periodically as he/she moves through this process and the mitigation strategy is submitted for approval. The system owner is expected to provide evidence to mitigate the finding in any of the approaches mentioned above. Once submitted for review and approval of the course of action, and evidence uploaded the finding can then be closed.

### Uploading an Evidence Package and Closure of Finding

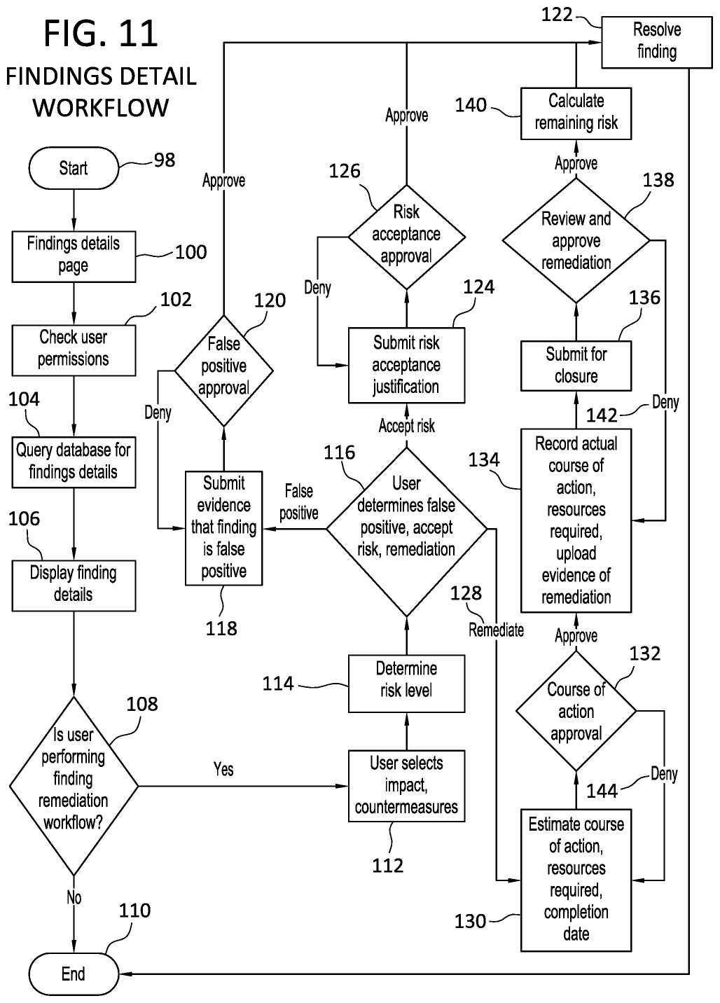

After completing the mitigation strategy, the finding will enter the Evidence Needed (EN) stage. In this stage, the plan of action is executed and the results documented. The documentation should be uploaded into OpenFISMA+ in order to create an evidence package that proves the plan of action was successful. With Successful approval of the evidence the finding is then considered remediated and closed (described below in more detail and illustrated, for example, in FIG. 11).

### Reports

Since Federal regulations require detailed reports, OpenFISMA+ has the capability to export these quarterly and annual FISMA reports or other defined reports such as Overdue Findings report.

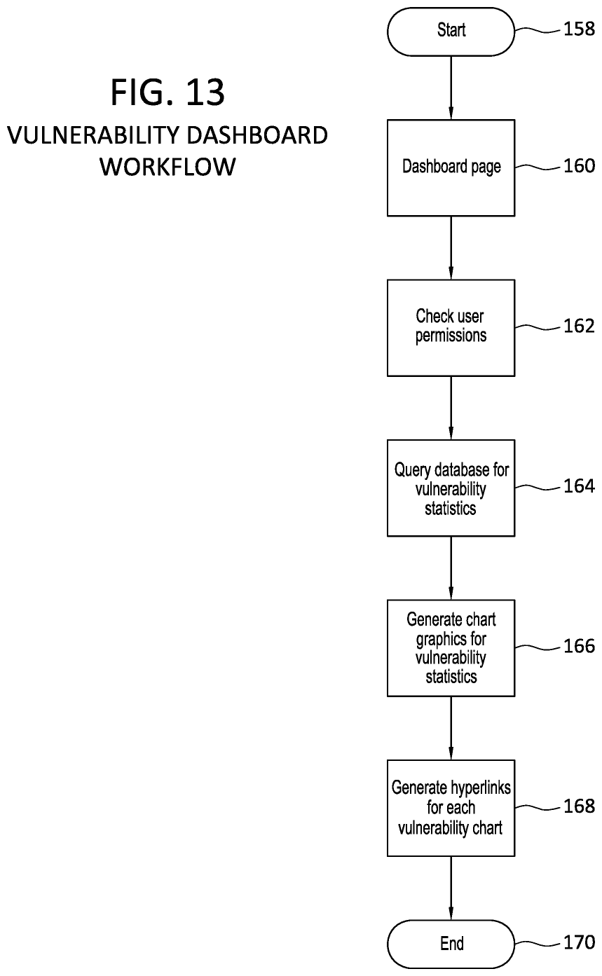

### Vulnerability Module (VM) (FIGS. 13-15)

OpenFISMA+ provides the capability to normalize and manage vulnerabilities from multiple security scanners. Consider OpenFISMA+ as a funnel you pour in scan data from a number of disparate sources, and OpenFISMA+—funnels all of that information into one repository that is easy to search and report against.

The Vulnerability Module (VM) allows the user to prioritize vulnerability remediation based on organizational risk. This type of analysis is difficult or impossible if your organization is running multiple security scanner products and does not have a unified vulnerability management system.

The vulnerability module is very similar to the Findings Module for permissions, workflow process and remediation.

The tool provides a dashboard view of the vulnerabilities found that management can review for critical, high, moderate and low levels. The number that have been mitigated and those that are in progress or past completion. (described below in more detail and illustrated, for example, in FIG. 13).

The VM module has a pluggable system for integrating with third party vulnerability scanners. OpenFISMA+ extracts information from the machine-readable output (generally XML) from the supported vulnerability scanner programs. OpenFISMA+ looks for the following types of information:
Vulnerability
Date Discovered
Description
Threat
Recommendation
Common Vulnerability Scoring System (CVSS), Common Vulnerabilities and Exposures (CVE), Bugtraq ID, and other vulnerability IDs

### Upload Scans

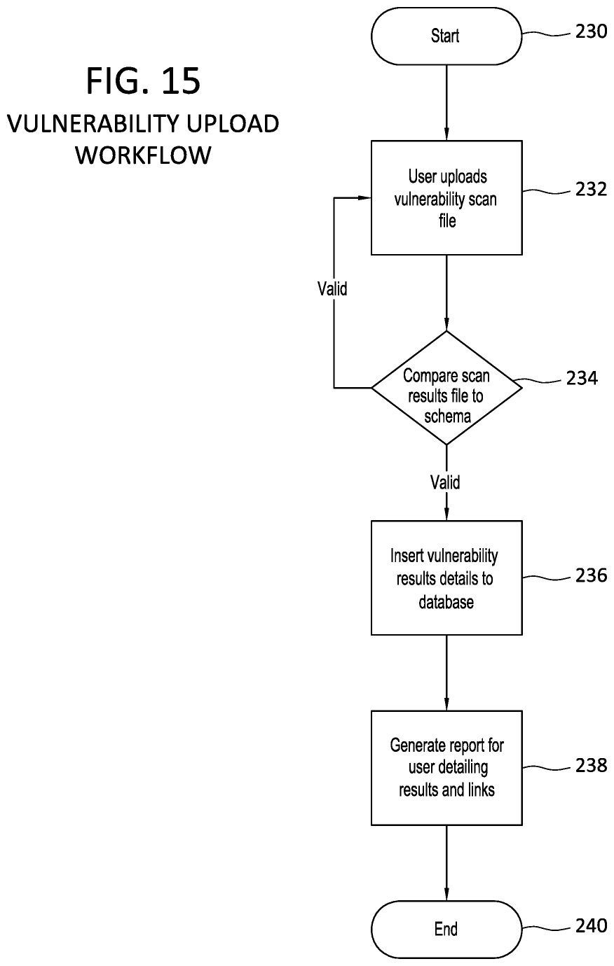

OpenFISMA+ is inter-operable with vulnerability scanners in several known formats. The scan results can be loaded directly into OpenFISMA+. OpenFISMA+ is clever enough not to re-introduce vulnerabilities, which already exist. (See the Injection Filtering paragraph below for details). In addition, OpenFISMA+ is extensible so that new scan report formats can be plugged into the existing architecture. The scan file is uploaded (See, for example, FIG. 15) and tracked to completion.

### Injection Filtering

OpenFISMA+ performs filtering on all injection plugins based on a fixed set of rules. The goal of filtering is to remove injected vulnerabilities which are duplicates of existing ones. A duplicate is defined as a vulnerability which meets the following requirements:
The affected asset is the same as a pre-existing vulnerability.
AND
The description of the vulnerability is exactly the same (word for word) as a pre-existing.
OR
The CVE of the vulnerability exactly the same as a pre-existing vulnerability.

When a duplicate is injected, OpenFISMA has several ways of handling it, depending on the status of the duplicated vulnerability.
If the original vulnerability is OPEN, then OpenFISMA suppresses the duplicate.
If the original vulnerability is FIXED, then OpenFISMA re-opens the original vulnerability.
If the original vulnerability is WONTFIX, then OpenFISMA suppresses the duplicate.

The vulnerability management workflow starts with the upload of the scan result, the user permissions are checked, database is quarried and the details of the vulnerabilities are displayed. The person to mitigate the vulnerability can be identified and the user acts in the possible corrective action approach that will be taken to mitigate the vulnerability. Risk analysis is conducted to identify the level of the threat to take the appropriate course of action such as terminate if it a false positive or if counter measures need to be put in place. Through a review and approval process the vulnerability is then closed. See FIG. 11 for the detailed process.

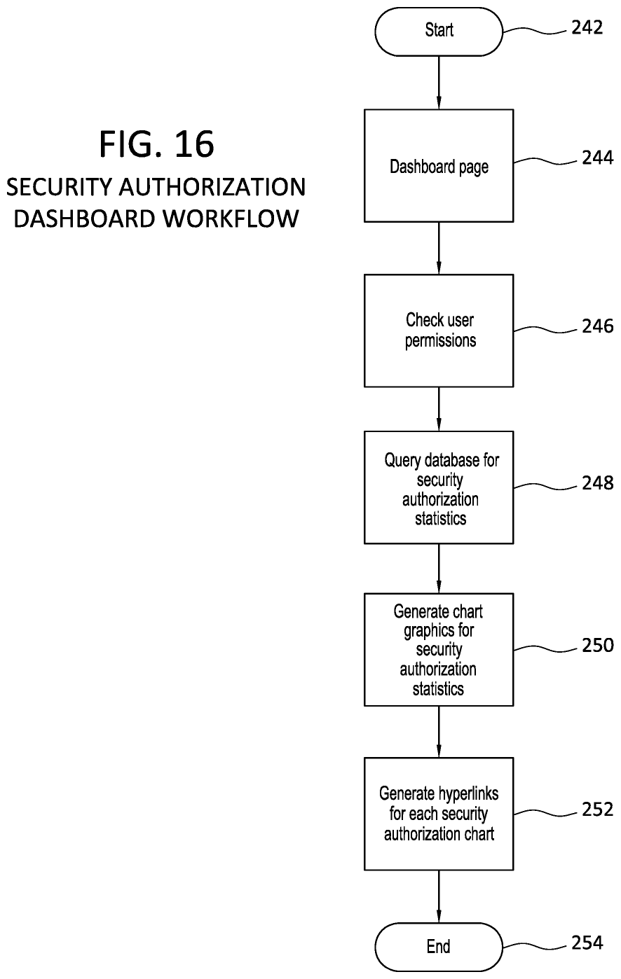

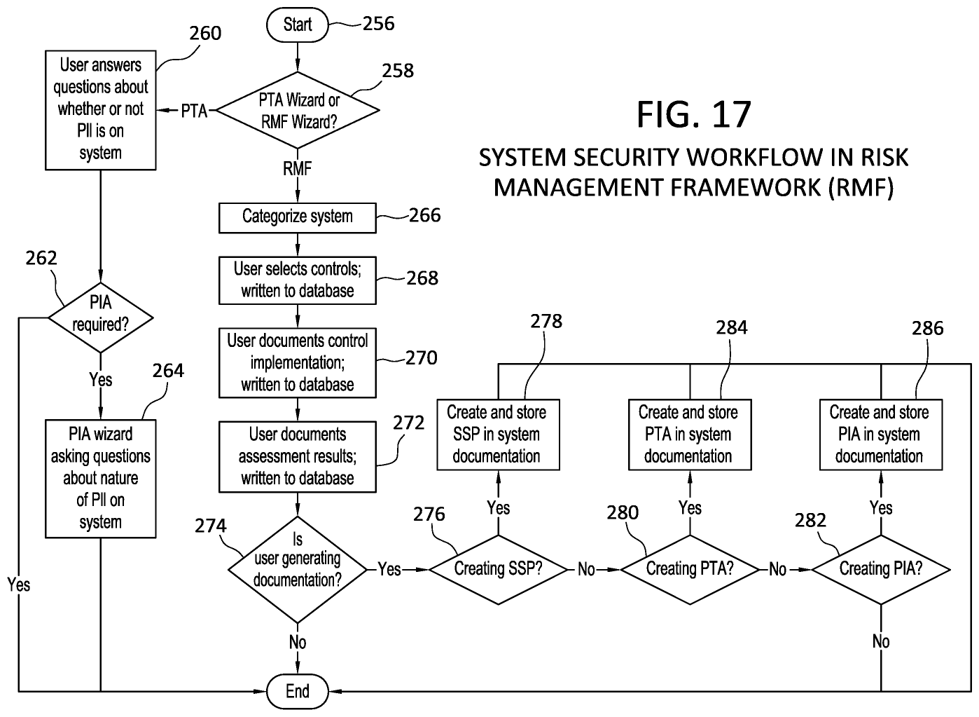

### Security Authorization Module (SAM) (FIGS. 16-17)

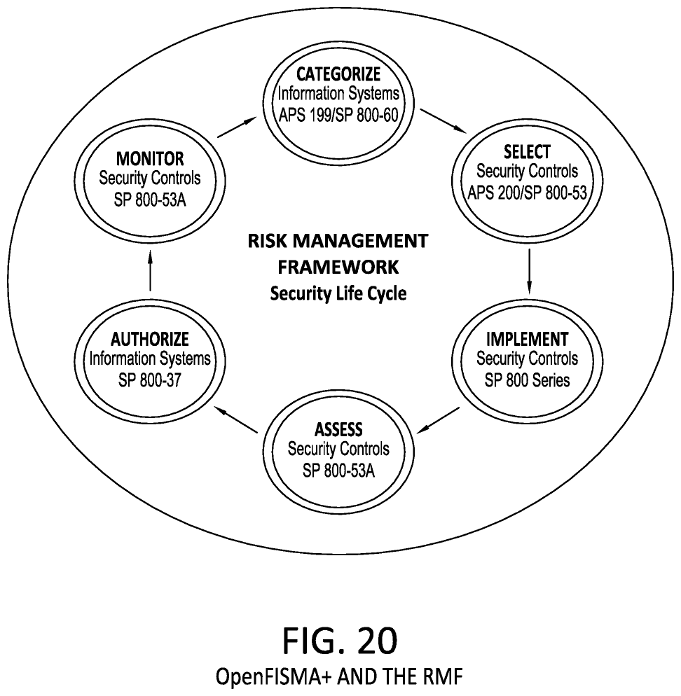

This module takes into account the entire NIST Risk Management Framework (RMF), shown in FIG. 20. The module has a dashboard view which provides the details of all security authorization activities for a system. See, for example, FIG. 16.

The process starts with creating a system in the tool under a defined organization. Categorizing the system based on NIST SP 800-60.

Once the system is categorized, the system undergoes its Privacy threshold analysis (PTA) and Privacy Impact analysis (PIA) within the tool to dynamically create the PIA report which can be printed or shared with other users as needed. After the categorization, the controls applicable to the categorization level can be selected taking into account the baseline controls, the inherited controls and the hybrid controls.

The user has the ability to add their implementation statements with reference to the requisite artefacts within the tool. This creates the automated Security Assessment Report (SAR) which can be provided to a third-party verifier to assess the controls.

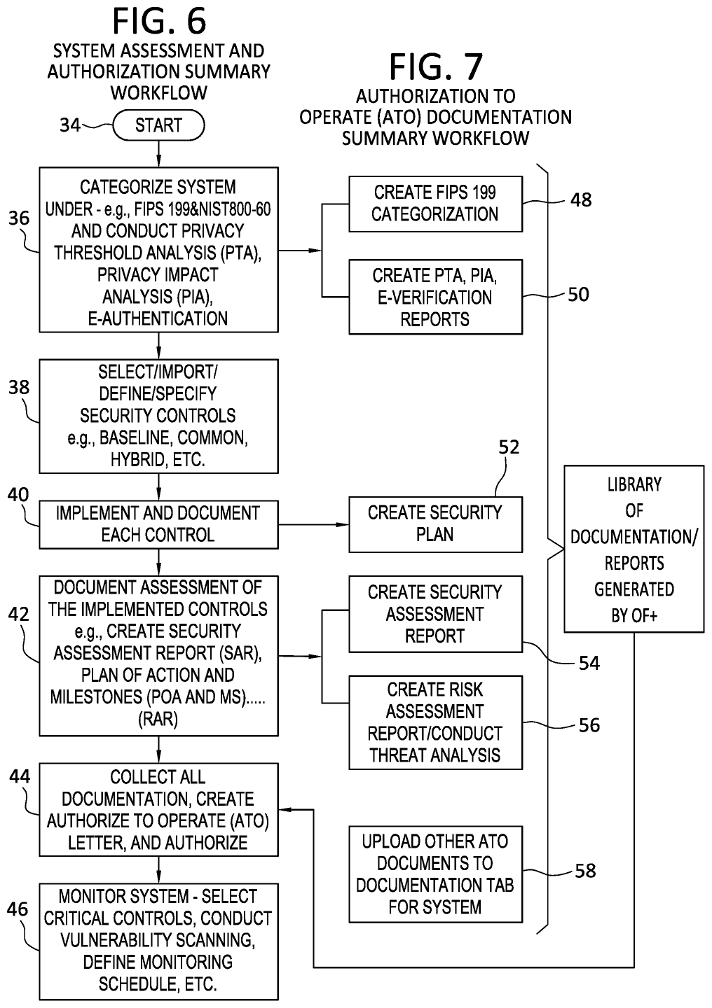

The implementation and assessment of the controls leads to a process to manage the continuous monitoring of the system. The system can create all the artefacts dynamically that are required for complete Authorization to Operate (ATO) package. See, for example, FIGS. 6-7, step 44.

### Incident Module (IM)

The module aims at tracking security incidents. It provides a very rich data model to capture contact details, threat source, affected assets, resolution steps, and both internal/external communication paths related to security incidents.

The tool can tie in with an organization's current ITSM solution to ensure that the tracking of the security incidents is accurately completed and centralized. Roles identified will be responsible for tracking the incident to completion.

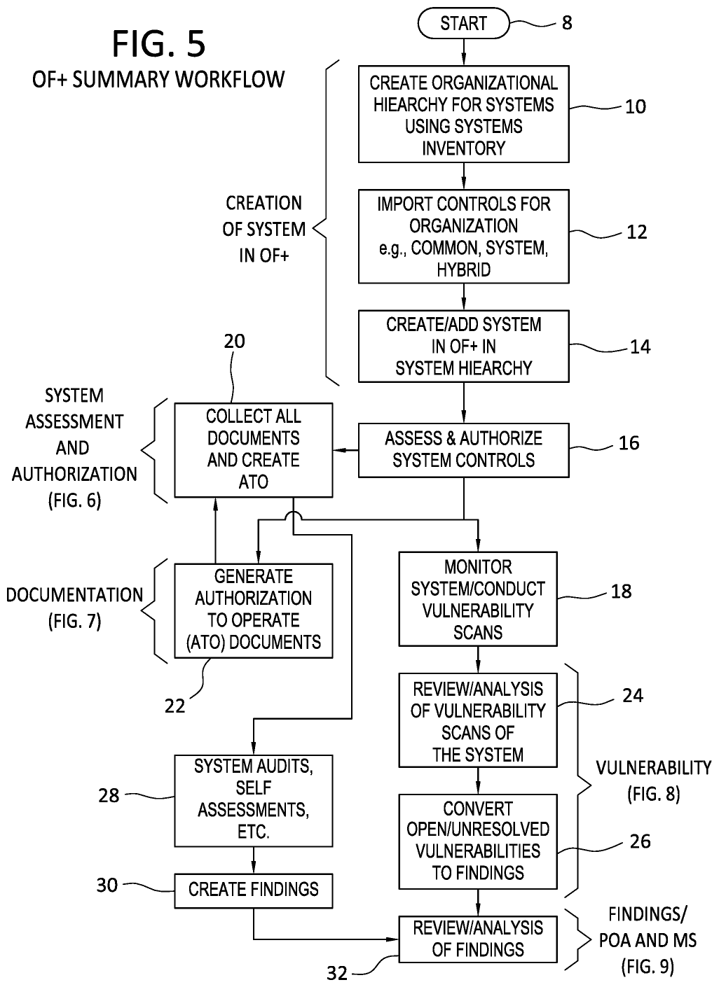

Referring to FIGS. 5-17, various workflows or flowcharts for a preferred embodiment of the method of the present invention will now be described. Specifically, FIG. 5 illustrates a summary workflow involving five main threads—Creation of System in OF⁺, System Assessment and Authorization, Documentation, Vulnerability, and Findings/POA&Ms.

The Creation of System in OF⁺ includes creating organizational hierarchy for various systems based on a systems inventory for an organization (step 10). Then, the desired controls for the organization, for example, common to various systems, specific to a particular system, and hybrid involving common and system controls are imported (step 12). Based on steps 10 and 12, the system to be secured and monitored is created or added in the OF⁺ tool at step 14.

The OF⁺ tool then follows the Assessment and Authorization thread to select and authorize system controls and begins monitoring the system (steps 16 and 18, respectively). Once the Assessment and Authorization thread is completed, but prior to system monitoring in step 18, it is followed by collecting all appropriate documentation to create Authorization to Operate (ATO) (step 20) and generate ATO documents/report (step 22). The documentation thread is followed by previewing/analyzing vulnerability scans of the system (step 24), and converting any open/unresolved vulnerability to findings (step 26). The final Findings/POA&Ms. thread involves receiving scan data from various system audits, self-assessments, etc. (step 28), and creating findings (step 30), which together with any unresolved vulnerabilities received in step 26, are reviewed and analyzed (step 32).

FIG. 6 illustrates the details of the System Assessment and Authorization thread, which upon start at 34 categorizes the system under, for example, FIPS 199 and NIST 800-60 requirements and conducts any Privacy Threshold Analysis (PTA), Privacy Impact Analysis (PIA), and/or e-authentication (step 36). This is followed by selecting/importing/defining/specifying the security controls, for example, base line, common, hybrid, etc. (step 38), which are then implemented and documented in step 40. The implemented controls are then assessed and documented by creating, for example, a Security Assessment Report (SAR), POA&Ms., RAR (Risk Assessment Report) at step 42. In the following step 44, all of the documentation is created, including those received from the next documentation thread (described below) to create an authorization to operate (ATO) letter/report for authorizing the system to be monitored in the following step 46. The monitoring step 46 includes, for example, selecting critical controls, conducting vulnerability scans, defining monitoring schedule, such as the selected controls once a year. 6

The Documentation thread (FIG. 7) includes receiving the category details/information from step 36 of the System Assessment and Authorization thread and creating FIPS 199 documents (step 48). Likewise, the details from PTA/PIA and/or e-authentication data/information are used to create PTA, PIA and e-authentication reports in step 50. Based on the implementation document for the controls in step 40, a system security plan document is created in step 52. The assessment documentation for the implemented controls in step 42 leads to creating a Risk Assessment Report or conduct threat analysis (step 56). In step 58, any other authorization to operate documentation are collected and uploaded to a documentation tab for the system for access by the user. All of the documentation/reports generated in steps 48, 50, 52, 54, 56, and 58 are then fed to the Assessment and Authorization thread for creating the ATO letter in step 44.

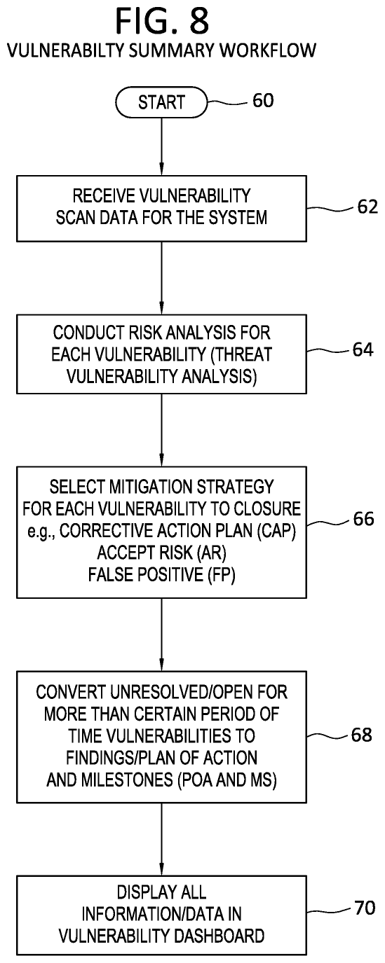

The Vulnerability summary workflow shown in FIG. 8, upon activation at 60 receives vulnerability scan data from audits, self-assessments, etc., (step 62) and conducts a risk analysis for each vulnerability (threat vulnerability analysis) at step 64, for user to select a mitigation strategy (step 66). The preferred mitigation options include, but not limited to, Corrective Action Plan (CAP), Accept Risk (AR), and False Positive (FP). An unresolved/open for more than a certain period of time vulnerability is converted to finding/POA&Ms. and transmitted to the findings/POA&Ms. thread (discussed below in detail in FIG. 9) at step 68. The vulnerability data/information is transmitted to the vulnerability dashboard in step 70.

The Findings/POA&Ms. summary workflow, upon activation at 72, receives system vulnerability findings from audits, self-assessments, vulnerability scans, etc., at 74 and conducts a risk analysis for each vulnerability (threat vulnerability analysis) (step 76), for the user to select a mitigation strategy, (step 78), which includes, but not limited to, Corrective Action Plan (CAP), Accept Risk (AR), and False Positive (FP) (step 78). At the following step 80, a POA&Ms. report is created and the information is transmitted to the findings dashboard (step 82).

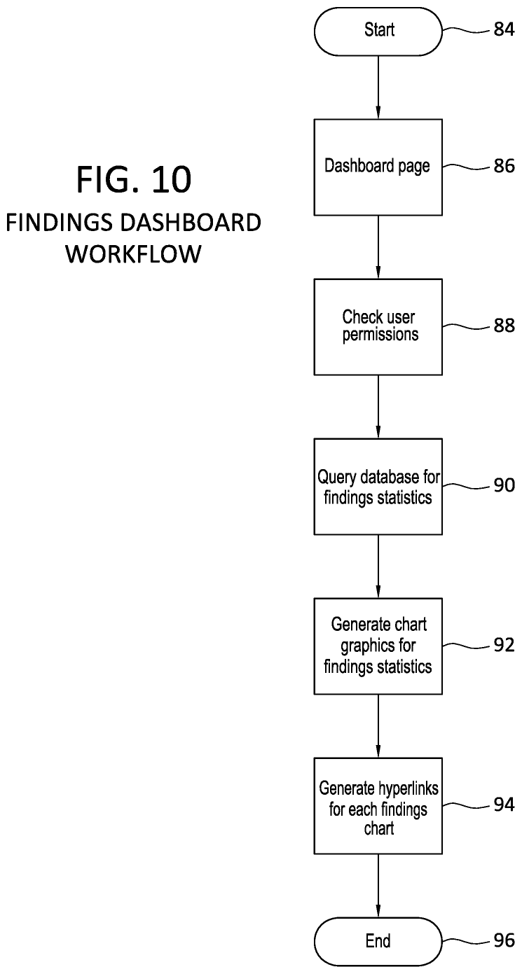

As shown in FIG. 10, an executive dashboard workflow/flow chart for the Findings Module (FM), upon activation (step 84), generates a dashboard page/screen (step 86) that allows a user to enter his/her security credentials (access data/details) for verification (step 88). A successful security credentials verification, allows the user to query the database for any statistics relating to the findings (step 90), followed by generating charts, graphics, details, etc. (step 92) thereof. Finally, the executive dashboard workflow generates hyperlinks to the charts/details/summaries corresponding to each finding (step 94) that the user can click on for obtaining access to further details, and the thread ends at 96.

As shown in FIG. 11, a workflow/flow chart for the Findings Module (FM), upon activation (step 98), generates a findings details page/screen (step 100) that allows a user to enter his/her security credentials (access data/details) for verification (step 102). A successful security credentials verification, allows the user to query the database for any details relating to the findings (step 104), followed by displaying charts, graphics, details, etc. (step 106) thereof. The user is then queried for performing a remediation workflow (step 108). If no, the process ends (step 110). If yes, the user selects impact counter measures at 112, and determines the risk level (step 114). The user determines to follow on of three remediation procedures—False Positive (FP), Accept Risk (AF), or Remediate (step 116). The FP route requires the user to submit evidence at step 118, which upon approval (step 120) leads to approval and the finding is considered resolved (at 122) and the process ends (at 110). IF the FP selection is denied, the user is prompted to re-submit evidence of FP (at 118). If the user decides to accept risk, the user submits justification for RA (step 124), and upon approval (step 126), the finding is resolved (at 122), and the process ends (at 110). As in the FP scenario, the user is prompted to re-submit risk acceptance evidence of AR, if denied (step 124).

Finally, if the Remediate option is selected by the user (step 128), an estimated course of action, resources required, completion date, etc., is submitted at step 130 for approval (step 132) which, upon acceptance, proceeds to record/store the estimated course of action details at step 134 and submitted for closure (step 136). Upon approval of remediation procedure (step 138), any remaining approval of remediation procedure (step 138), any remaining risk is estimated/calculated (step 140), and the finding is resolved (step 122), and the process ends (step 110). If the request for closure approval is denied (step 142), the recording step is repeated for the course of action details (step 134). If, earlier in the process at step 132, the course of action estimation details is denied at step 144, the user is prompted to revise/re-submit the course of action details (step 130) and the process repeats as aforementioned.

More particularly, as shown in FIG. 12, a finding upload workflow/flow chart, upon activation (step 146), allows a user to upload a findings report file (step 148), which is then compared for validity (step 150). If invalid, the user is prompted to re-load the file. A valid scan allows the user to enter the finding details into the database at step 152. The user may then generate a report (step 154) detailing the results and the associated links for further use, and the thread ends at 156.

Specifically, as shown in FIG. 13, an executive dashboard flowchart for vulnerability upon activation (step 158), generates a dashboard page/screen (at 160) that allows a user to enter his/her security data/credentials (access data/details) for verification (step 162). A successful security credentials verification, allows the user to query the database for any statistics relating to vulnerability (step 164), followed by generating charts, graphics, statistics, (step 166). Finally, the executive dashboard workflow/flowchart generates hyperlinks to each vulnerability (step 168) that the user can click on for obtaining access to further details, and the thread ends at 170.

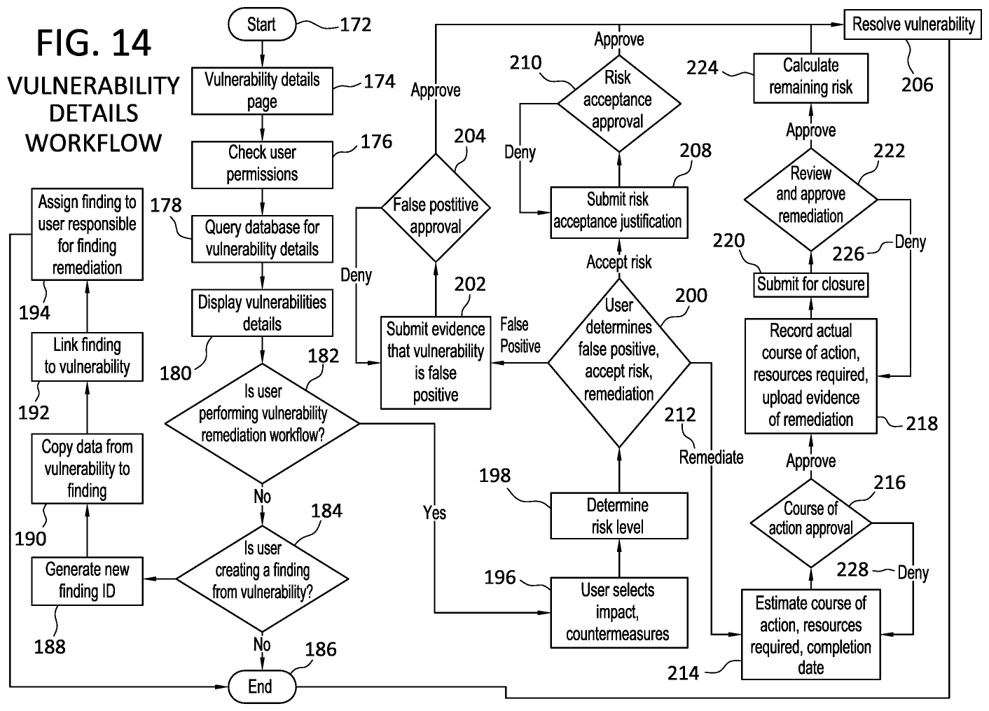

As shown in FIG. 14, a workflow/flow chart for the Vulnerability Module (VM), upon activation (step 172), generates a vulnerability details page/screen (step 174) that allows a user to enter his/her security credentials (access data/details) for verification (step 176). A successful security credentials verification, allows the user to query the database for any details relating to the vulnerabilities (step 178), followed by displaying charts, graphics, details, etc. (step 180) thereof. The user is then queried for performing a remediation workflow (step 182). If no, a query is made at step 184 whether the user is creating a finding from a vulnerability (FIG. 8, step 68); if not, the process ends at 186. If yes, a new finding ID is created (step 188), the relevant data is copied from vulnerability to the Finding Module (FM) (step 190), and the two are linked (step 192). The new finding thus created is assigned to a user responsible for remediation (step 194), and the process ends at 186. If the remediation query is yes, the user selects impact countermeasures at 196, and determines the risk level (step 198). The user determines to follow one of the three remediation procedures—False Positive (FP), Accept Risk (AF), or Remediate (step 200). The FP route requires the user to submit evidence at step 202, which upon approval (step 204) leads to approval and the finding is considered resolved (at 206) and the process ends (at 186). If the FP selection is denied, the user is prompted to re-submit evidence of FP (step 202). If the user decides to accept risk, the user submits justification for RA (step 208), and upon approval (step 210), the finding is resolved (at 206), and the process ends at 186. As in the FP scenario, the user is prompted to re-submit risk acceptance evidence of AR, if denied (step 208).

Finally, if the Remediate option is selected by the user (step 212), an estimated course of action, resources required, completion date, etc., is submitted at step 214 for approval (step 216), which, upon acceptance), proceeds to record/store the estimated course of action details (at 218) and submitted for closure (step 220). Upon approval of the remediation procedure (step 222), any remaining risk is estimated/calculated (step 224), and the vulnerability is resolved (step 206) and the process ends (step 186). If the request for closure approval is denied (step 226), the recording step is repeated for the course of action details (step 218). If, earlier in the process at step 216, the course of action estimation details is denied at step 228, the user is prompted to revise/re-submit the course of action details (step 214) and the process repeats as aforementioned.

More particularly, as shown in FIG. 15, a vulnerability upload workflow/flow chart, upon activation (step 230), allows a user to upload a vulnerability scan file (step 232), which is then compared for validity (step 234). If invalid, the user is prompted to re-load the file. A valid scan allows the user to enter the vulnerability results details into the database at step 236. The user may then generate a report (step 238) detailing the results and the associated links for further use, and the thread ends at 240.

FIG. 16 shows an executive dashboard workflow/flow chart for the Security Authorization Module (SAM), which upon activation (step 242), generates a dashboard page/screen (step 244) that allows a user to enter his/her security credentials (access data/details) for verification (step 246). A successful security credentials verification, allows the user to query the database for any statistics relating to the security authorization (step 248), followed by generating charts, graphics, details, etc. (step 250) thereof. Finally, the executive dashboard thread (flow chart) generates hyperlinks to the charts/details/summaries corresponding to each security authorization (step 252) that the user can click on for obtaining access to further details, and the thread ends at 254.

FIG. 17 illustrates a workflow/flowchart for the Security and Authorization Module (SAM). Upon activation (step 256), a query is made for PTA (Privacy Threat Analysis) wizard or RMF (Risk Management Framework) wizard (step 258). Upon selection of PTA, the user answers questions about whether or not PII (Personally Identifiable Information) is on the system (step 260). A further query is made if PIA (Privacy Impact Analysis) is required (step 262), and if yes, the PIA wizard asks questions about the nature/details of the PII on the system (step 264). If not, the process ends at step 266. At step 258, if RMF is selected, the system is categorized at step 266 (as discussed in detail above and shown in FIG. 6, step 36), and the user selects controls to be input to the database (step 268). The user documents the control implementation (step 270) and assessment results (step 272) to be input to be database. If the user decides not to generate documentation (step 274), the process ends at 266. However, if the user selects to generate documentation at step 274 step, a query is made for creating a SSP (step 276), and if yes, the SSP (System Security Plan) is created and stored in system documentation (step 278) and the process ends at 266. If the query for creating SSP results in the negative, a second query is made for creating PTA (step 280), and if no, a final query is made for creating PIA (step 282). If the queries for creating PTA and PIA result in the affirmative, PTA and PIA are created and stored in system documentation at steps 284 and 286, respectively, and each individually ends at 266.

### OpenFISMA+ Technologies and Architecture

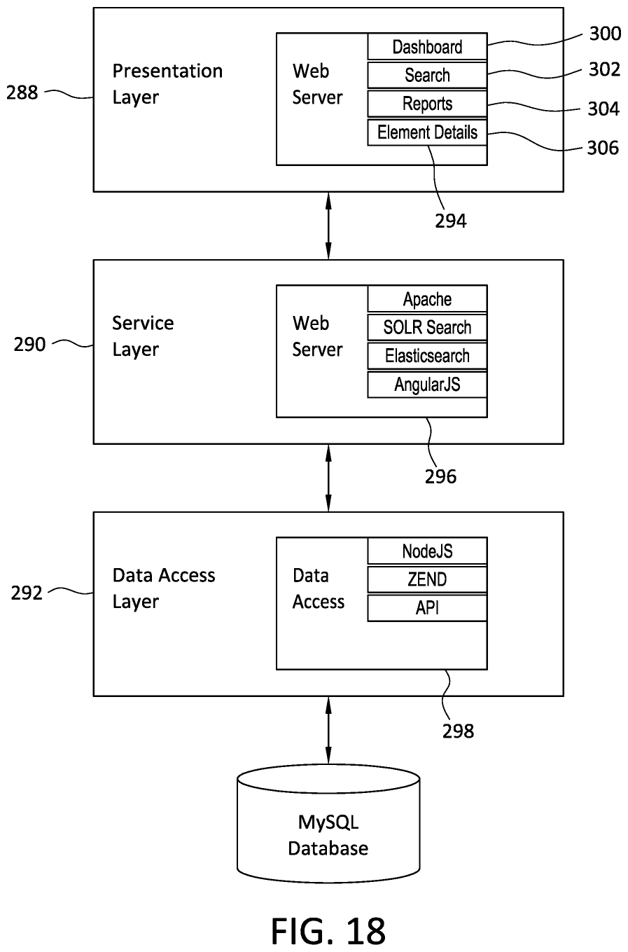

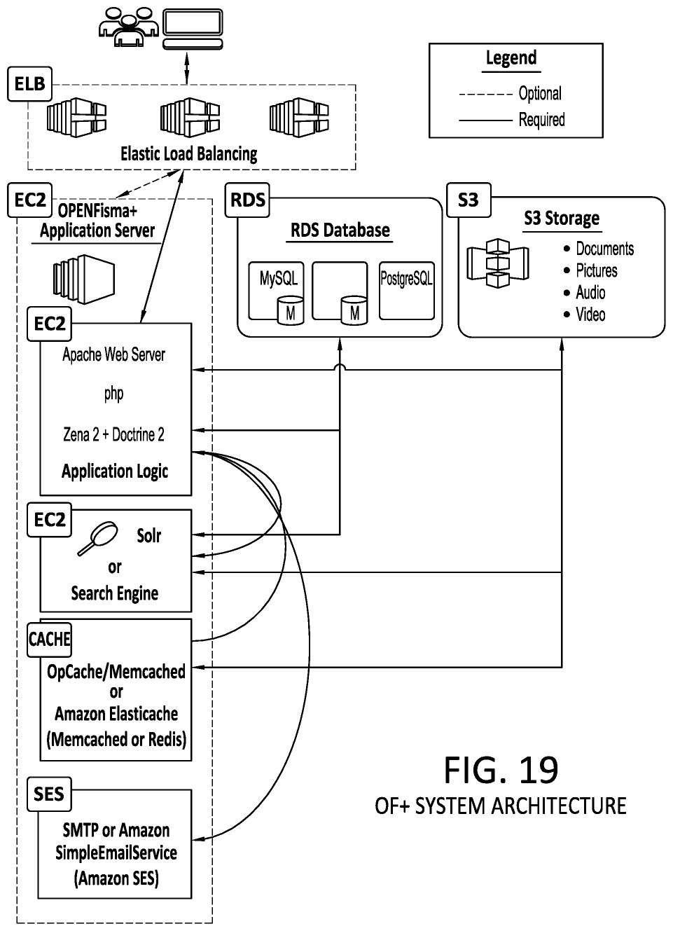

Preferably, as shown in FIGS. 18-19, OpenFISMA+ is a PHP-MySQL based web application that runs on an Apache server.

Technologies that may be used include, but not limited to:
LAMP Technologies (Linux, Apache MySQL and PHP)
Amazon Web Services (AWS)
Nessus and SonarQube
Amazon Web Services (AWS)
Nessus and SonarQube

In particular, as shown in FIG. 18, OpenFISMA+ includes a Presentation Layer 288, a Service Layer 290, and a Data Access Layer 292, which function as a web interface 294, a web server 296, and a data access 298, respectively. The web interface 294 preferably includes a Dashboard link 300, a Search link 302, a Reports link 304, and an Element Details link 306. The web server 296 can be supported on various known platforms, including Apache, SOLR Search, Elasticsearch, and Angular JS. Likewise, various known databases may be used for the data access 298, such as Nodel JS, ZEND, and API.

### OpenFISMA+ and the RMF

OpenFISMA+ automates all the features of the NIST Risk Management Framework (RMF), and provides Security Management functionality throughout the NIST RMF. Specifically, as shown in FIG. 20, OpenFISMA+ follows the NIST's security lifecycle for the RMF: Categorize, Select, Implement, Assess, Authorize, and Monitor.

### Security and Compliance Frameworks

OpenFISMA+ addresses various frameworks including, but not limited to—
CNSS 1253
Fed RAMP
Agency directives
DOD-DITSCAP/DIACAP
ISO 27001/27002
GBLA
SOX
NIST 800-171
FERPA

The OpenFISMA+ tool can be used in various industries. Provided below are the target industries for each module—

Findings Module and Vulnerability Module
Federal Government and their Contractors/Suppliers to the Federal Government
State Government and their contractors
Banking
Education
Virtually any Industry and/or Framework that gets audited and has to track its actions.

Security Authorization Module
Private Contractors/Suppliers to the Federal Government
State Government and their contractors
Education

Inventory Module
All industries

Incident Module
All industries

### Non-Limiting Benefits to Customers/Users

To reduce the cost of FISMA compliance and reporting, including continuous monitoring operations. OpenFISMA+ automation will help with reducing the time spent on the everyday tasks and spending more time on the security risks.

### Advantages of OpenFISMA+

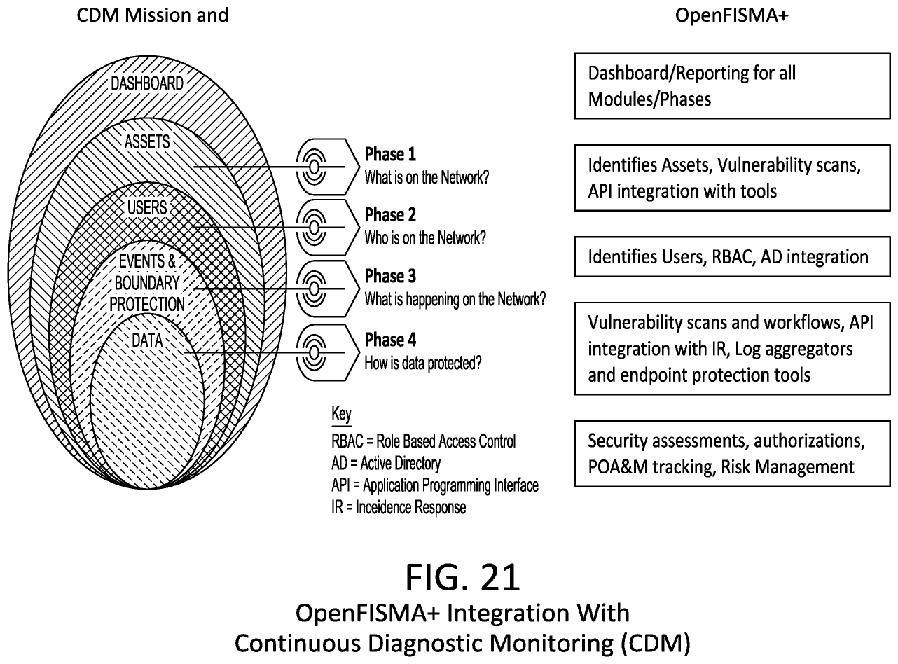

From a review of the specification and drawings herein, one skilled in the art would appreciate that OpenFISMA+ can at least effectively deliver compliance, threat levels, and risk management data in comprehensible views for immediate analysis and action. Main features include, but not limited to—
Flexibility, Ease-of-use, Customizable
Simple User interface
Role Based Access-Granular/Customizable
Lightweight Directory Access Protocol (LDAP) Integration
Scan Upload/Bulk Findings Upload
Email Notifications
Management Reporting
Training
Customized Workflow
Multiple frameworks
Hosted and Non-Hosted
Customizable DHS Continuous Diagnostic Monitoring (CDM) Integration (FIG. 21).

It is noted herewith that the terms “computer,” “computing device,” “system,” “network” include computers, personal computers, computing devices, communication devices, laptops, mobile devices, notebooks, tablets, platforms, servers, networks, the Internet, global network of computers, wearable computing devices, wearable mobile devices, wearable communication devices, websites, social networking sites or systems or networks, or similar devices available now or in future.

It is noted herewith that while the present invention has been described/illustrated be referring to various governmental laws, standards, etc., it is not limited to or by those laws, standards, etc., and is applicable and scalable to non-governmental databases, environments, infrastructures, platforms, requirements, systems, organizational needs, etc.

It is also noted herewith that while the present invention has been described/illustrated by using various technologies/platforms currently available, it would be versatile and adaptable to later developed technologies/platforms.

It is further noted herewith that the method(s) or step(s) of the invention need not be performed in the order written or illustrated, or as recited in the claims. They can be performed in a different order.

While this invention has been described as having preferred sequences, ranges, steps, order of steps, materials, structures, symbols, indicia, graphics, color scheme(s), shapes, configurations, features, components, software module(s), hardware module(s), system architecture(s), or design(s), it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the claims appended hereto or presented later. The invention, therefore, is not limited to the preferred embodiment(s) shown/described herein.

What is claimed is:

1. A computing device-implemented method of managing a security risk in a computer system or network, comprising the steps of:
a) determining an appropriate security level for the computer systems or network;
b) selecting, using a security authorization module, one or more suitable controls applicable to the security level based on one or more predetermined criteria;
c) implementing the selected one or more controls;
d) monitor the system or network for any vulnerability;
e) reporting any vulnerability found to a vulnerability module for remediation;
f) tracking, using the vulnerability module, the progress of the remediation to completion;
g) reporting to a findings module for remediation, if the vulnerability is not remediated within a preset period of time;
h) tracking, using the findings module, the progress of the remediation reported in step g) to completion.

2. The method of claim 1, wherein:
the remediation in step e) comprises determining a threat level for the vulnerability found in step e).

3. The method of claim 2, wherein:
the threat level comprises at least one member selected from the group consisting of critical, high, moderate, low, and a combination thereof.

4. The method of claim 3, comprising:
determining a remediation response comprising at least one member selected from the group consisting of accept risk, false positive, and correction.

5. The method of claim 1, wherein:
the preset period of the time in step g) comprises 15-60 days.

6. The method of claim 1, wherein:
the vulnerability reported in step g) is logged on the findings module as a finding reportable to a governmental authority.

7. The method of claim 6, wherein:
any unresolved finding is classified as a Plan of Action and Milestones (POA&Ms).

8. The method of claim 1, further comprising:
i) filtering out a vulnerability determined to be a duplicate of a pre-existing vulnerability.

9. The method of claim 8, further comprising:
j) suppressing or re-opening the duplicate vulnerability based on one or more preset conditions.

10. The method of claim 9, wherein:
the duplicate vulnerability is suppressed if the pre-existing vulnerability is either open, or not remediable.

11. The method of claim 9, wherein:
the duplicate vulnerability is re-opened, if the pre-existing vulnerability has been remediated.

12. The method of claim 1, wherein:
the vulnerability or finding comprises a deficiency in the computer system or network.

13. A computing device-implemented method of identifying and tracking to closure a security risk, threat, or deficiency in a computer system or network, comprising the steps of:
a) parsing, using a vulnerability module, scanned data from a computer system or network;
b) identifying any vulnerability based on compliance with one or more predetermined criteria;
c) reporting any vulnerability found in step b) to an administrator for remediation;
d) tracking, using the vulnerability module, the progress of the vulnerability remediation to completion;
e) reporting to a findings module for further remediation, if the vulnerability remediation is not completed within a preset period of time; and
f) tracking, using the findings module, the progress of the remediation reported in step e) to completion.

14. The method of claim 13, wherein:
the remediation in step c) comprises determining a threat level for the vulnerability found in step b).

15. The method of claim 14, wherein:
the threat level comprises at least one member selected from the group consisting of critical, high, moderate, low, and a combination thereof.

16. The method of claim 15, comprising:
determining a remediation response comprising at least one member selected from the group consisting of accept risk, false positive, and correction.

17. The method of claim 13, wherein:
the preset period of time in step e) comprises 15-60 days.

18. The method of claim 13, wherein:
the vulnerability reported in step e) is logged in the findings module as a risk, threat, or deficiency reportable to a governmental authority.

19. The method of claim 18, wherein:
any unresolved risk, threat, or deficiency is classified as a Plan of Action & Milestones (PAO & Ms).

20. The method of claim 13, further comprising:
g) filtering out a vulnerability determined to be duplicate of a pre-existing vulnerability.

21. The method of claim 20, further comprising:
h) suppressing or re-opening the duplicate vulnerability based on one or more preset conditions.

22. The method of claim 21, wherein:
the duplicate vulnerability is suppressed if the pre-existing vulnerability is either open or not remediable.

23. The method of claim 21, wherein:
the duplicate vulnerability is re-opened, if the pre-existing vulnerability has been remediated.

24. The method of claim 13, wherein:
the vulnerability or finding comprises a security risk, threat, or deficiency in the computer system or network.

25. A non-transitory computer-readable medium with instructions stored thereon, that when executed by a processing device, perform the steps comprising:
a) parsing, using a vulnerability module, scanned data from a computer system or network;
b) identifying any vulnerability based on compliance with one or more predetermined criteria;
c) reporting any vulnerability found in step b) to an administrator for remediation;
d) tracking, using the vulnerability module, the progress of the vulnerability remediation to completion;
e) reporting to a findings module for further remediation, if the vulnerability remediation is not completed within a preset period of time; and
f) tracking, using the findings module, the progress of the remediation reported in step e) to completion.

26. The non-transitory computer-readable medium of claim 25, comprising instructions for causing the processing device to:
determine a threat level for the vulnerability reported in step c).

27. The method of claim 26, wherein:
the threat level comprises at least one member selected from the group consisting of critical, high, moderate, low, and a combination thereof.

28. The method of claim 27, comprising instructions for causing the processing device to:
determine a remediation response comprising at least one member selected from the group consisting of accept risk, false positive, and correction.

29. The method of claim 25, comprising instructions for causing the processing device to:
Logging, in the findings module, the vulnerability reported in step e) as a risk, threat, or deficiency reportable to a governmental authority.

30. The method of claim 25, comprising instructions for causing the processing device to:
filter out a vulnerability determined to be a duplicate of a pre-existing vulnerability.

31. The method of claim 30, comprising instructions for causing the processing device to:
suppress or re-open the duplicate vulnerability based on one or more preset conditions.

32. The method of claim 31, comprising instructions for causing the processing device to:
suppress the duplicate vulnerability if the pre-existing vulnerability is either open, or not remediable.

33. The method of claim 31, comprising instructions for causing the processing device to:
re-open the duplicate vulnerability, if the pre-existing vulnerability has been remediated.

34. A processing device, comprising:
the computer-readable medium of claim 25.

35. A processing device having stored thereon the instructions of claim 25.

36. A computer network, comprising:
the computer-readable medium of claim 25.

37. A system for identifying and tracking to closure a security risk, threat, or deficiency in a computer system or network, comprising:
a) a first processor that runs a vulnerability module for:
i) scanning data from a computer system or network to identify a vulnerability based on compliance with one or more predetermined criteria;
ii) reporting the vulnerability found to an administrator for remediation;
iii) tracking the progress of the vulnerability remediation to completion; and
iv) reporting to a findings module for remediation if the vulnerability remediation is not completed within a present period of time;
b) a second processor that runs a findings module for:
i) tracking the progress of the vulnerability remediation received from the vulnerability module to completion; and
ii) logging the received vulnerability remediation from the vulnerability module as a risk, threat, or deficiency reportable to a governmental authority;
c) a third processor that runs a security and authorization module for:
i) selecting, based on one or more predetermined criteria, one or more security controls applicable to a security level for the computer system or network; and
ii) implementing the selected one or more security controls in the computer system or network.

38. The system of claim 37, wherein:
the first, second, and third processors are the same processor.

39. The system of claim 37, wherein:
the scanning step i) is initiated by the first processor at a predetermined interval of time.

40. The system of claim 37, wherein:
the scanning step i) is carried out by the first processor in real time.
